(19) United States
(12) Patent Application Publication
(10) Pub. No.: US 2010/0010825 A1
(43) Pub. Date: Jan. 14, 2010

(54) MULTICULTURAL AND MULTIMEDIA DATA COLLECTION AND DOCUMENTATION COMPUTER SYSTEM, APPARATUS AND METHOD

(76) Inventor: Linda H. Kunz, Cedarburg, WI (US)

Correspondence Address: JOSEPH S. HEINO, ESQ.;DAVIS & KUELTHAU, S.C., 111 E. KILBOURN, SUITE 1400, MILWAUKEE, WI, 53202-6613, US

(21) Appl. No.: 12/500,404

(22) Filed: Jul. 9, 2009

Related U.S. Application Data
(60) Provisional application No. 61/079,171, filed on Jul. 9, 2008.

(51) Int. Cl. G06F 3/048; G06F 17/00; G06Q 10/00; G06F 3/00

(52) U.S. Cl. 705/1; 715/773; 715/221; 715/201; 715/704

(57) ABSTRACT

An improved computer system, input apparatus and method for providing a user-interactive means for completing common forms in the healthcare industry, such as a Minimum Data Set (MDS) collection form that is used for nursing home resident assessment and care screening. In addition to providing a caregiver fillable form, the claimed invention teaches a patient fillable form in which the patient is guided through the form using a scripted interview approach.

This application claims the benefit and priority of U.S. Provisional Patent Application No. 61/079,171 filed Jul. 9, 2008.

### FIELD OF THE INVENTION

The present invention relates generally to the field of computers, peripheral computer devices and software methods that enable user interaction with computers, particularly of the type where data and information is collected and documented. More particularly, it relates to an improved multicultural and multimedia data collection and documentation computer system, method and input apparatus that allows the user to augment printed display text with electronically stored data in the form of text presented in other languages, verbalization of the text, and/or video images that are relevant to the message being conveyed by the text. More particularly, it also relates to an interactive interviewing system, method and apparatus for use by a user where, in a particular embodiment of the present invention, the user is a patient who interacts with a nursing home assessment tool during the patient interview process.

### BACKGROUND OF THE INVENTION

Computers are invaluable tools and their use continues to proliferate and permeate most aspects of human society. It is well known in the computer arts that a complete computer system generally comprises control units, input devices, storage devices, an operating system, and output devices. Input devices are peripheral devices that generate input for the computer system and include such devices as a keyboard, a track-ball, a “mouse,” a hand-guided device which when moved on a flat surface moves the cursor on a computer display screen, and other like devices. For example, there are many applications where computer input, or the access of stored information, is accomplished by using a touch sensitive display device, or “touch screen” that senses tactile contact by a user or by a stylus that is held by the user. Although touch screens are relatively new, they are, by today's standards, old in the art of peripheral computer devices. In the typical touch screen, the user is provided with a screen display that may have one or more indicia, words or icons situated within a region of the display and that the user may touch to access information represented by that index, word or icon. Upon touching the index, word or icon, the screen display changes and may present further touch screen options, and so on. It is also recognized by these inventors that display technology continues to advance into the areas of digital screen films and “smart paper,” a material that has the look and feel of thick stock paper but which is actually a controllable display surface. Collectively, any such device and any conventional monitor or display screen shall be referred to in this disclosure simply as a “display.”

With the prior art of the system, method and apparatus of currently-pending U.S. patent application Ser. No. 11/722,148 in mind, this inventor believes that a significant improvement in the system, method and apparatus disclosed in that Application can be made. In her view, what is needed is an improvement whereby the user is provided with the ability to utilize an added automated and interactive interview component to the display. Such an improvement would allow the user to be “prompted” to answer interview questions by an automated interviewer, and even an animated one, that would be “user friendly.” In the view of this inventor, the improvement would allow the user to select the most appropriate choice for a given question and also allow the user to dynamically interact with an interviewer by means of an audio, animated or video vignette that can even be tailored specifically to that user.

The improved system, method and apparatus would provide the user with access to the written word, to a verbalization of the written word, in any language, and to an active visual display of the message being conveyed in a form other than that of the written word that is user-specific. Such capability can and, in the view of this inventor, does enhance comprehension and understanding of the message that the display is intended to convey, making the user's response to that message significantly more meaningful and accurate regardless of the culture and language of the interviewed user.

However, in the view of this inventor, what is also needed is an improvement to the foregoing whereby the user may, in a specific embodiment of the present invention, be a patient who is provided with the ability to interact with a portion of the nursing home assessment tool of the type that is generally disclosed in the above-mentioned prior art application.

### SUMMARY OF THE INVENTION

Accordingly, a primary object of the present invention is to provide an improved computer system, input apparatus and method whereby a user can experience an interactive electronic interview using the improved system, apparatus and method.

Another object of the present invention is to provide such an improved system, apparatus and method whereby the user's experience can be tailored to that user to enhance and maximize the quantitative and qualitative input solicited from the user during the interactive electronic interview.

It is yet another object of the present invention to provide such an improvement for use by a user where, in a particular embodiment of the present invention, the user is a caregiver or a patient who interacts with a nursing home assessment tool.

In accordance with the aforementioned objectives, there is provided an improved computer system, input apparatus and method in accordance with the application mentioned above, the disclosure of which is incorporated herein by reference. In the improvement of the present invention, the user may, in one preferred embodiment, be the patient who interacts with a portion of the nursing home assessment tool. In this preferred embodiment, the form is a Minimum Data Set (MDS) collection form that is used for nursing home resident assessment and care screening. In addition to the electronic configuration of a form that asks for information mandated by Medicare for proper patient reporting and provider reimbursement, the electronic configuration would be further modified to accommodate the “scripted interview” approach that will be mandated for use with the new MDS 3.0 format.

By taking a multicultural and multimedia approach to this type of data gathering, and by combining it with the novel electronic interviewing interface present by the present invention, the gathered information is likely to be more accurate and consistent, and thus more useful and valuable, to those who must use the information for various purposes.

The foregoing and other features of the system, apparatus and method of the present invention will be apparent from the detailed description that follows.

### DETAILED DESCRIPTION

The present invention provides, in general terms, an improved computer system and method that use an input apparatus in the form of a touch screen to present a screen display that includes at least one query and multiple words or phrases in response to that query in a first language. The user may select the most appropriate word or phrase in response to the given query or may select a change of the written language for the words or phrases presented such that the same words or phrases are presented in a second or other language. The screen display also allows the user to select a verbalization and enunciation of the words or phrases in the first, second or other language. The screen display also enables the user to view an animated or video vignette display that represents the meaning of the words or phrases displayed and/or verbalized whereby the user's understanding of the words or phrases is further enhanced. This system and method, as disclosed in the prior art application mentioned earlier, minimizes multicultural considerations which results in the input of information by the user that is more consistent and meaningful.

It is to be understood that the improved system, apparatus and method of the present invention is not limited to any one particular type of peripheral input device or display device. That is, the input device could include a touch screen display, a keyboard, a track-ball, a mouse, a stylus, or any other similar device of current of future intended use. Any such device may be used without deviating from the scope of the present invention.

In a specific preferred embodiment of the improved system, apparatus and method of the present invention, the touch screen is used to enter data onto a screen-generated form that is shown on a screen display, the form having multiple points of consideration, or queries. In this preferred embodiment, the electronically-generated form will be a Minimum Data Set (MDS) Version 3.0 data gathering or collection or observation documentation form that will be used for nursing home resident assessment and care screening, which form will be shown in the English language and will assume the electronic configuration of a hard-copy form, a form that will include data and observation documentation that is essentially mandated by the Medicare program.

The MDS Version 3.0 form will be substantially similar to the currently used MDS Version 2.0 form, but will differ in one significant aspect. Specifically, the MDS Version 3.0 form will require that the nursing home resident's voice be used to complete a “scripted interview” approach to document to completion.

In the nursing home setting, it is acknowledged that residents and their families want patient care to be accurately reported. However, they also want patient care to be as individualized as possible. It has also been recognized that, in the nursing home setting, residents know how they feel and what they want. Knowing that most residents can answer questions about the things that are important to them, it is important to solicit direct resident input whenever possible. That is, the residents themselves are in the best position to provide substantial input about their physical and emotional well-being to the caregiver. For example, they can tell a care giver about their pain, their sadness, what is important to them, and much more. With these observations in mind, the MDS Version 3.0 form is a tool that is well suited for soliciting resident input. The bottom line is that the MDS Version 3.0 form accomplishes a major “shift” in assessment philosophy—from the emphasis on staff observation and record review to incorporating the resident's own voice in the assessment process. By doing so, the MDS Version 3.0 form assessment respects the individual's desires, needs and priorities.

It is intended that the MDS Version 3.0 form assessment will also be used in situations where residents are known to have cognitive impairment and it is intended to be utilized with many who have significant impairment.

The “scripted interview” approach mentioned above is also recognized to be capable of providing improved reliability as to the nature of responses that are solicited to specific questions posed by the MDS Version 3.0 form, much the same as it does with the current MDS Version 2.0 form. In the view of this inventor, however, the utilization of a strictly “question and answer” format with individuals who may have limited attention span or cognitive ability can result in a rather boring, and perhaps even inaccurate, reporting experience, both of which have a direct effect on the patient's treatment assessment. If the resident is disinterested or inattentive, assessments may not be as accurate as they could be such as where the resident is interested and fully engaged in the scripted interview process.

In the view of this inventor, the utilization of an electronic interview methodology whereby a character, real or fictitious, and is one with whom the patient can relate, is much more likely to be an effective solicitor of resident input. By way of example, the interview could be conducted by a fictitious or a real person, including one with which the patient is familiar, if only on a “celebrity” basis, such as a famous person in the field of entertainment. That is, an engaging interview process could be had between a resident of the age and vintage who would be familiar with certain celebrities. In the age bracket of a patient in the range of 70 to 90 years of age, one such celebrity could be, for example, Fred Astaire. In that setting, the animated or visually identifiable character of Fred Astaire would be used to ask the patient user-specific questions, all in accordance with the “scripted interview” approach mentioned above. By having Fred Astaire ask the resident the pertinent questions and by having the resident respond appropriately to those questions, the resident would be engaged with this fictional interviewer. In the experience of this inventor, the patient interviewee would be more responsive, more complete in his or her response, and more forthright in sharing his or her conditions of well-being with such person. It is also believed that the resident would be motivated to reply in a much more fully-responsive and engaging exchange.

If the patient was not one who was familiar with Fred Astaire, other solicitor options could be presented by the care-giver. The interviewer could be a cartoon character or some other person that is familiar to the resident. Since the questions to be asked would be electronically-generated in audio-visual fashion by using the improved system, apparatus and method of the present invention, a wide range of such characters could be uploaded into the system software for the purpose of establishing this audio-visual familiarity with the resident interviewee.

There would, however, be another reason to provide the option of using different characters during the interview process. The ability to “change-up” the characters during this type of interview process would also minimize resident boredom in the overall process. That is, each experience with the “scripted interviewer” would effectively be a new experience for that resident and not one that the resident would be likely to simply provide rote answers to. This is particularly important given the frequency with which any MDS assessment is required to be given. Always answering questions posed by Fred Astaire would likely become uninteresting after many assessments, even for the most avid Fred Astaire fan. Having another character as the “scripted interviewer” from time to time would keep the interviewee interested in the process.

As alluded to earlier, the identity of the character used would be selected by the caregiver from a menu of many available fictional, nonfictional or historic interviewers. The identity would be selected and then the interview process with the resident would commence to conclusion. The resident may or may not require assistance with the electronic entry of the appropriate response, but would essentially use the same display that would be available to the care-giver user for entry of the other resident-specific information, including Activities of Daily Living, or ADL, information that the care-giver user would need to solicit from the resident. The audio-visual display would be integrated with the overall system used in the assessment process and used in accordance with the MDS methodology.

It would also be possible in the improved system, apparatus and method of the present invention to utilize “voice-only” methodology whereby the voice of the familiar character, such as the celebrity mentioned above, is used to solicit input from the patient using that familiar voice. The option of using the voice-only scripted interview assessment would also be selected by the caregiver as would the menu of fictional, nonfictional or historic interviewer voices available to the resident. The identity would be selected and then the interview process with the resident would commence to conclusion. The resident may or may not require assistance with the electronic entry of the appropriate response to the audio interview question asked, but would essentially use the same display that would be available to the care-giver user for entry of the other ADL information mentioned above. Particularly for residents using the claimed invention, the interview questions can be repeated as many times as necessary. The display and the audio component would be integrated with the overall system used in the assessment process and used in accordance with the MDS methodology.

By taking an interactive approach to this “scripted interview” type of data gathering, the gathered information is more accurate and consistent and, thus, more valuable to those who must use the information for various purposes.

It is also to be understood that the invention of the present application could be utilized elsewhere and in other settings. For example, the scripted interview approach could be used with patients who are not being cared for in a traditional nursing home setting, but at home. The methodology would be substantially the same, but with the data input device being at that patient's home. The transmission of data would be enhanced, and in all other respects the scripted interview would be conducted as described in this detailed description. Accordingly, it will be understood that the system, apparatus and method of the present invention is not limited to the preferred embodiment disclosed herein.

Based upon the foregoing, it will be apparent that there has been provided a new, useful and non-obvious computer system, input apparatus and method that facilitates the use of a display in a way that presents multiple words or phrases in a first language and from which the user may select the most appropriate word or phrase in response to the given query; that allows the user to also selectively change the written language for the words or phrases presented such that the same words or phrases are presented in a second or other language, but having essentially the same meaning; that also allows the user to selectively listen to a verbalization and enunciation of the words or phrases in the first, second or other language; that also allows the user to selectively view an animated or video vignette display that represents the meaning of the words or phrases; that also allows the user to participate in a scripted interview approach that utilizes a fictional, nonfictional or other character to solicit responses from the user; that allows the character to be varied as desired or required; all of which enhances the user's understanding of the words or phrases and whereby multicultural, multilingual and other considerations are minimized and whereby inputted information is entered in a more consistent and accurate manner.

The principles of this invention having been fully explained in connection with the: foregoing, we hereby claim as our invention:

1. A system for acquiring and managing data comprising:
at least one input computer, said at least one input computer having a processing program, at least one display device, said display device having a visual display and a plurality of visually simulated push buttons within the visual display for accessing portions of the processing program;
a sound generating means; and
means for operably coupling said at least one input computer, said at least one display device and said sound generating means;
wherein the processing program is operable to conduct a scripted interactive electronic interview comprising oral questions presented to an interviewee, the interviewee being prompted to respond to the questions presented using the visually perceptible display, the visually perceptible display being operable to provide a video display representative of the question being conveyed in the scripted interview and a visually perceptible display of potential responses to the question conveyed.

2. The data acquisition and management system of claim 1 wherein a plurality of push buttons are presented such that an interviewee may select between a scripted oral interview in one of a first, second and other languages.

3. The data acquisition and management system of claim 1 wherein the processing program of the at least one input computer provides a display of a virtual form, said form having at least one area that presents the interviewee with written text that includes the interview question and a plurality of possible responses to the question.

4. The data acquisition and management system of claim 1 wherein the processing program allows the interviewee to replay a portion of the scripted interview.

5. The data acquisition and management system of claim 4 wherein the processing program allows the interviewee to select at least one simulated pushbutton to visually present the question and the responses in a video representation in a context separate from the interview.

6. The data acquisition and management system of claim 5 wherein the scripted interview is presented to the interviewee by a real or fictitious character.

7. An apparatus for use with a system for acquiring and managing data comprising:
at least one computer having a processing program;
at least one display device, said display device having a visual display and a plurality of visually simulated push buttons within the visual display for accessing portions of the processing program; and
a sound generating means, which comprises an input device, means for operably coupling the input device with the at least one computer and with the at least one display device and said sound generating means;
wherein the processing program is operable to conduct a scripted interactive electronic interview comprising oral questions presented to an interviewee, the interviewee being prompted to respond to the questions presented using the visually perceptible display, the visually perceptible display being operable to provide a video display representative of the question being conveyed in the scripted interview and a visually perceptible display of potential responses to the question conveyed.

8. The apparatus of claim 7 wherein a plurality of simulated push buttons are presented, one for each of the first, second and other languages.

9. The apparatus of claim 7 wherein the processing program of the at least one input computer provides a display of a virtual form, said form having at least one area that presents the interviewee with written text that includes the interview question and a plurality of possible responses to the question.

10. The apparatus of claim 7 wherein the processing program allows the interviewee to replay a portion of the interview.

11. The apparatus of claim 10 wherein the processing program allows the interviewee to select at least one simulated button to visually present the question and the responses in a video representation in a context separate from the interview question.

12. The data acquisition and management system of claim 11 wherein the scripted interview is presented to the interviewee by a real or fictitious character.

13. A method for acquiring and managing data which comprises the steps of:
providing at least one input computer, said at least one input computer having a processing program;
providing at least one display device, said display device having a visual display and a plurality of computer generated pushbuttons within the visual display for accessing portions of the processing program;
providing sound generating means, and
operably coupling said at least one input computer, said at least one display device and said sound generating means,
wherein the processing program is operable to conduct a scripted interactive electronic interview comprising oral questions presented to an interviewee, the interviewee being prompted to respond to the questions presented using the visually perceptible display, the visually perceptible display being operable to provide a video display representative of the question being conveyed in the scripted interview and a visually perceptible display of potential responses to the question conveyed.

14. The data acquisition and management method of claim 11 wherein a plurality of simulated push buttons are presented, one for each of the first, second and other languages.

15. The data acquisition and management method of claim 12 wherein the processing program of the at least one input computer provides a display of a virtual form, said form having at least one area that presents the interviewee with written text that includes the interview question and a plurality of possible responses to the question.

16. The data acquisition and management method of claim 13 wherein the processing program of the at least one input computer provides a display of a virtual form, said form having at least one area that presents the interviewee with written text that includes the interview question and a plurality of possible responses to the question.

17. The data acquisition and management method of claim 16 wherein the processing program allows the interviewee to replay a portion of the interview.

18. The data acquisition and management method of claim 17 wherein the processing program allows the interviewee to select at least one simulated button to visually present the question and the responses in a video representation in a context separate from the interview question.
